(19) United States
(12) Patent Application Publication
(10) Pub. No.: US 2017/0093917 A1
(43) Pub. Date: Mar. 30, 2017

(54) CENTRALIZED MANAGEMENT AND ENFORCEMENT OF ONLINE BEHAVIORAL TRACKING POLICIES

(71) Applicant: Fortinet, Inc., Sunnyvale, CA (US)

(72) Inventors: Sekhar Sumanth Gorajala Chandra, Milpitas, CA (US); Liming Wu, Pleasanton, CA (US)

(73) Assignee: FORTINET, INC., Sunnyvale, CA (US)

(21) Appl. No.: 14/871,106

(22) Filed: Sep. 30, 2015

(51) Int. Cl. H04L 29/06; H04L 29/12; H04L 29/08

(52) U.S. Cl. CPC H04L 63/20; H04L 67/02; H04L 61/2007; H04L 67/22; H04L 63/0236; H04L 63/0281

(57) ABSTRACT

Systems and methods for manipulating online behavioral tracking policies are provided. According to one embodiment, a hypertext transfer protocol (HTTP) response transmitted from a web server to a client is captured by a network security device. A status of the client is determined by the network security device. An online behavioral tracking policy associated with the client is identified by the network security device based on the determined status. The identified online behavioral tracking policy is enforced by the network security device by modifying the HTTP response. The modified HTTP response is transmitted by the network security device to the client.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015, Fortinet, Inc.

### BACKGROUND

Field

Embodiments of the present invention generally relate to the field of network security techniques. In particular, various embodiments relate to the manipulation by firewalls of the usage of online behavioral tracking tools by servers (e.g., web servers and/or web analytics servers) so as to protect the privacy of network users in accordance with online communication privacy regulations of the country in which the user is geographically located.

Description of the Related Art

Network users' online activities may be tracked by online behavioral tracking tools, such as Hypertext Transfer Protocol (HTTP) cookies, web beacons and the like. An HTTP cookie is a small piece of data sent from a web server to a browser when the browser accesses the website. The HTTP cookie may be stored at the user's client machine. Every time the user loads the website again, the browser sends the HTTP cookie of the website back to the web server to notify the website of the user's previous activity. HTTP cookies are designed to be a reliable mechanism for websites to remember stateful information. When everything is working correctly, cookies cannot carry viruses and cannot install malware on the host computer; however, tracking cookies and especially third-party tracking cookies are commonly used as ways to compile long-term records of individuals' browsing histories. The potential privacy concerns have prompted European, U.S. and other countries' law makers to take action to restrict the usage of HTTP cookies and other online tracking tools. The online communication privacy regulations (e.g., digital privacy laws or cookie laws) of various countries differ concerning the usage of online behavioral tracking tools, such as HTTP cookies. Regulations of some countries require an explicit consent from a user before a web server can use cookies, while other countries allow implicit consent. Further, regulations of some countries require a cookie banner to be displayed at the top of a web page to show the cookie policy of the website, while others require only the availability of a link to a cookie policy.

In order to comply with the disparate online communication privacy regulations of multiple countries, a web server may introduce scripts within a home page of an enterprise's website in order to display an appropriate cookie banner to a first time visitor to the website, for example. The web server may introduce scripts to implement different kinds of cookie banners depending upon the geographic locations of the visitors in order to comply with the regulations of the visitors' countries. The administrator of the web server may maintain multiple cookie policies as well as cookie banners to comply with the regulations of different countries. For a company that has a large number of web servers, it is difficult to maintain online behavioral tracking policies at each web servers in order to comply with all potential current and future regulations. Therefore, it would be helpful to have a centralized mechanism or a proxy to manage the online behavioral tracking policies for all servers within a corporate network.

### SUMMARY

Systems and methods are described for centralized management of online behavioral tracking policies. According to one embodiment, a hypertext transfer protocol (HTTP) response transmitted from a web server to a client is captured by a network security device. A status of the client is determined by the network security device. An online behavioral tracking policy associated with the client is identified by the network security device based on the determined status. The identified online behavioral tracking policy is enforced by the network security device by modifying the HTTP response. The modified HTTP response is transmitted by the network security device to the client.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an exemplary network architecture in accordance with an embodiment of the present invention.

FIG. 2 illustrates exemplary functional units of a reverse proxy in accordance with an embodiment of the present invention.

FIG. 3A-3D illustrate exemplary cookie banners and privacy/cookie policy links of web pages in accordance with embodiments of the present invention.

FIG. 4 is a flow diagram illustrating a method for enforcing online behavioral tracking policies by a reverse proxy in accordance with an embodiment of the present invention.

FIG. 5 is an exemplary computer system in which or with which embodiments of the present invention may be utilized.

### DETAILED DESCRIPTION

Systems and methods are described for managing online behavioral tracking policies. According to one embodiment, a reverse proxy or a network security device implementing a reverse proxy captures a Hypertext Transfer Protocol (HTTP) response that is transmitted from a web server to a client. The reverse proxy determines a status of the client and determines an online behavioral tracking policy associated with the client based on one or more characteristics or a status (e.g., a physical or geographical location) of the client. The reverse proxy applies the online behavioral tracking policy to the HTTP response (e.g., by removing one or more non-compliant HTTP cookies or one or more non-compliant scripts from the HTTP response and/or by embedding one or more compliant HTTP cookies and/or one or more compliant scripts within the HTTP response) and transmits the revised HTTP response to the client in order to ensure online communications between the client and web server (and any analytics relating thereto or usage thereof) are in compliance with the online communication privacy regulations of the country in which the client is physically located.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

If the specification states a component or feature “may”, “can”, “could”, or “might” be included or have a characteristic, that particular component or feature is not required to be included or have the characteristic.

The phase “security device” generally refers to a hardware device or appliance configured to be coupled to a network and to provide one or more of data privacy, protection, encryption and security. The network security device can be a device providing one or more of the following features: network firewalling, VPN, antivirus, intrusion prevention (IPS), content filtering, data leak prevention, antispam, antispyware, logging, reputation-based protections, event correlation, network access control, vulnerability management. load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

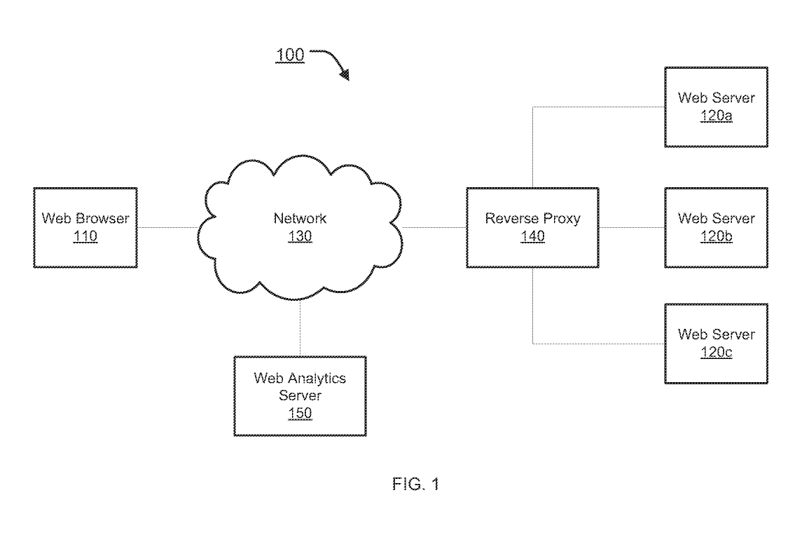

FIG. 1 illustrates an exemplary network architecture 100 in accordance with an embodiment of the present invention. In the present example, network architecture 100 includes at least a browser 110, multiple web servers 120a-120c, a reverse proxy 140 and a web analytics server 150. The network appliances 110, 120, 140 and 150 may be connected by a network 130, which may be any type of network, such as a local area network (LAN), a wireless LAN, a wide area network (WAN), or the Internet.

According to HTTP, when browser 110 accesses web server 120a, for example, for the first time, an HTTP request without an HTTP cookie is sent from browser 110 to web server 120a. In an HTTP response, web server 120a may transmit one or more HTTP cookies of web server 120a (within one or more HTTP Set-Cookie headers, for example), e.g., a first-party cookie, together with other content back to browser 110 in a session between browser 110 and web server 120a. Web browser 110 may store the HTTP cookie within a local storage when the session with the web server is closed. In another example, an HTTP cookie may be created locally by a script of web server 120a that is transmitted to browser 110. For example, web server 120a may include within the HTTP response scripting language code (e.g., a JavaScript function) that creates an HTTP cookie when run by browser 110.

In some examples, web server 120a may also include a script of a third-party, such as analytics server 150, in the HTTP response. After the third-party script of analytics server 150 is received by browser 110, browser 110 may run the third-party script and setup a connection with analytics server 150. A third-party HTTP cookie of analytics server 150 may be transmitted to browser 110 and stored locally at browser 110.

When browser 110 accesses web server 120a subsequently and a corresponding HTTP cookie is stored within browser 110, the HTTP cookie of the web server 120a is included in a header field (e.g., an HTTP Cookie header) of an HTTP request and sent to web server 120a automatically. When the HTTP request with the HTTP cookie is received by web server 120a, the HTTP cookie may be parsed thereby allowing web server 120a to determine, for example, that browser 110 is a return visitor and/or restore a previous state of the last session with browser 110 based on the HTTP cookie. Similar to the first-party HTTP cookie, the third-party HTTP cookie that is stored at browser 110 is included in an HTTP request and transmitted back to analytics server 150 when browser 110 subsequently accesses analytics server 150. Analytics server 150 may parse the HTTP cookie and the user of the HTTP cookie may be identified based on the ID field of the cookie. Analytics server 150 may track users' web surfing activities by accumulating access histories of the users.

In the present example, reverse proxy 140 is logically interposed between clients, such as browser 110, and servers, such as web servers 120a-120c and provides forwarding service in the exchange between the clients and the servers. Reverse proxy 140 may set up transmission control protocol (TCP) connections separately with browser 110 and a web server and relays data between the TCP connections. Reverse proxy 140 is most commonly used to provide load balancing, encryption services for scalability and availability. In the present example, reverse proxy 140 may also be used for manipulating the effect of online behavioral tracking policies implemented by web servers, such as web servers 120a-120c. Reverse proxy 140 may intercept an HTTP request from browser 110 and forward it to one of web servers 120a-120c based on its load balancing policies. If the request from browser 110 is transmitted encrypted by HTTP Secure (HTTPS) protocol, the encrypted request may be decrypted by reverse proxy 140 and then the HTTP request may be intercepted by reverse proxy 140. When an HTTP response is received from a web server, reverse proxy 140 may apply a corresponding online behavioral tracking policy to the HTTP response based on one or more characteristics or a status (e.g., the geographic location) of the visitor. After the proper web tracking policy is applied, reverse proxy 140 forwards the revised HTTP response to browser 110. The HTTP response may be encrypted if HTTPS is in use.

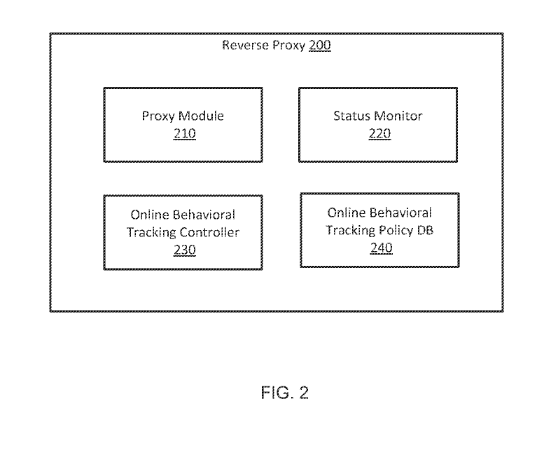

According to one embodiment, the online behavioral tracking policy applied to the HTTP response is in compliance with online communication privacy regulations of the visitor's country or an option explicitly or implicitly consented to or selected by the visitor. In such an embodiment, if the visitor is a first time visitor, reverse proxy 140 may determine from which country the visitor is accessing the web server and what cookie policy is required by the country. If the cookie policy of the country requires a cookie banner to be displayed on the web page to warn the user that HTTP cookies may be used by the web server, reverse proxy 140 may inject a script within the HTTP response to cause the required cookie banner to be displayed by the user's browser. If the cookie policy of the country requires an explicit consent from user before any cookie is used, a consent link or button may be included within the cookie banner. The visitor may click the consent link or button shown within the cookie banner if the visitor consents to the usage of HTTP cookies of web servers. The visitor's selection may then be sent back to the reverse proxy 140 or web servers 120a-120c. After reverse proxy 140 receives the consent of cookie usage from the user, reverse proxy 140 may embed HTTP cookies or implement or apply other tracking policies on or to the HTTP response that is to be sent to browser 110. Exemplary structures and functions of reverse proxy 140 are described in detail below with reference to FIGS. 2, 3 and 4.

FIG. 2 illustrates exemplary functional units of a reverse proxy in accordance with an embodiment of the present invention. In this example, reverse proxy 200 includes a proxy module 210, a status monitor 220, an online behavioral tracking controller 230 and an online behavioral tracking policy database 240.

Proxy module 210 is used for providing forwarding service in the exchange between clients and servers. Proxy module 210 may set up TCP connections with clients and set up separate TCP connections with servers and relays data between the TCP connections. Proxy module 210 may intercept an HTTP request from a client and forward it to a selected web server based on its load balancing policies, for example. When an HTTP response is received from the web server by proxy module 210, the HTTP response may be revised appropriately based on an online behavioral tracking policy associated with the client to override a potentially conflicting online behavioral tracking policy implemented by the web server. The revised HTTP response may then be forwarded to the client, thereby ensuring that any tracking tools used by the web server are in compliance with applicable online communication privacy regulations and/or desires determined implicitly or explicitly conveyed by the user via the client.

Online behavioral tracking policy database 240 may be used for storing information regarding online communication privacy regulations of countries and privacy options corresponding to clients. For example, online behavioral tracking policy database 240 may collect information for multiple countries including one or more of the following:
1. whether a privacy policy link is required to be included in a web page;
2. whether a dedicated cookie policy link is required to be included in a web page;
3. whether a cookie banner is required to be included in a web page;
4. required formatting of the cookie banner, including fonts, size and position of the cookie banner;
5. whether an explicit consent to the usage of cookies is required; and
6. whether implicit consent to cookie usage is permitted.

Online behavioral tracking policy database 240 may also store options that are selected by visitors of web servers regarding what tracking tools are allowed by the visitors. For example, online behavioral tracking policy database 240 may store selections made by visitors regarding one or more of the following
1. web beacons (e.g., consent or non-consent to use thereof);
2. HTTP cookies (e.g., consent or non-consent to use thereof);
3. first-party HTTP cookies (e.g., consent or non-consent to use thereof);
4. third-party HTTP cookies (e.g., consent or non-consent to use thereof);
5. whitelisted and/or blacklisted third-party HTTP cookies;

Online behavioral tracking policy database 240 may also include corresponding scripts, functions, rules and/or commands that are used to implement specific online communication privacy regulations and visitors' options. For example, one or more appropriate HTTP cookies and/or scripts may be selected by online behavioral tracking controller 230 based on the status of a particular visitor to the website and may be embedded within an HTTP response by reverse proxy 200 in order that the usage of tracking tools of the website is compliance with corresponding regulations and users' options. Alternatively or additionally, HTTP cookies and/or scripts embedded by web servers may be removed by reverse proxy 200 if such HTTP cookies and/or scripts are inconsistent with the stored information regarding online communication privacy regulations of the country at issue and/or privacy options corresponding to the client at issue.

Status monitor 220 is used for detecting a status of a visitor of an HTTP request that is intercepted by proxy module 210. Status monitor 220 may determine from which country the client is visiting the web server. The country or the location of the client may be determined based on a source IP address of the HTTP request or other information indicative of the physical location of the client included in the HTTP request (e.g., Global Positioning System (GPS) location information). Status monitor 220 may also determine whether the visitor is a first time visitor or a return visitor. In one example, if an HTTP cookie of the web server is included in the HTTP request from the client, then the client is determined to be a return visitor. If no HTTP cookie is included in the HTTP request, then the client is determined to be a first time visitor. In another example, status monitor 220 may maintain a browsing log that records information regarding clients that have accessed resources of the web servers. For example, a web beacon may be placed on one or more web pages hosted by the web server. Whenever a request to access a web page on which a particular web beacon is located is received from a client, status monitor 220 may store information regarding the request, including a source IP address, a time of the visit and the like within the browsing log. When an HTTP request from a client is intercepted, status monitor 220 may check the browsing log of the client. If the client cannot be found within the browsing log, the client may be determined to be a first time visitor. If the web beacon has been accessed by the client before, the client may be determined to be a return visitor.

Status monitor 220 may further determine an amount of time that has elapsed since the last access for a return visitor. If the amount of time exceeds a predetermined or configurable threshold, status monitor 220 may determine that a particular cookie policy is to be implemented for the client when the client is a return visitor.

Online behavioral tracking controller 230 is used for implementing online behavioral tracking policies. For example, online behavioral tracking controller 230 may apply a particular online behavioral tracking policy to HTTP traffic associated with a particular client based on a status of the client that has been determined by status monitor 220.

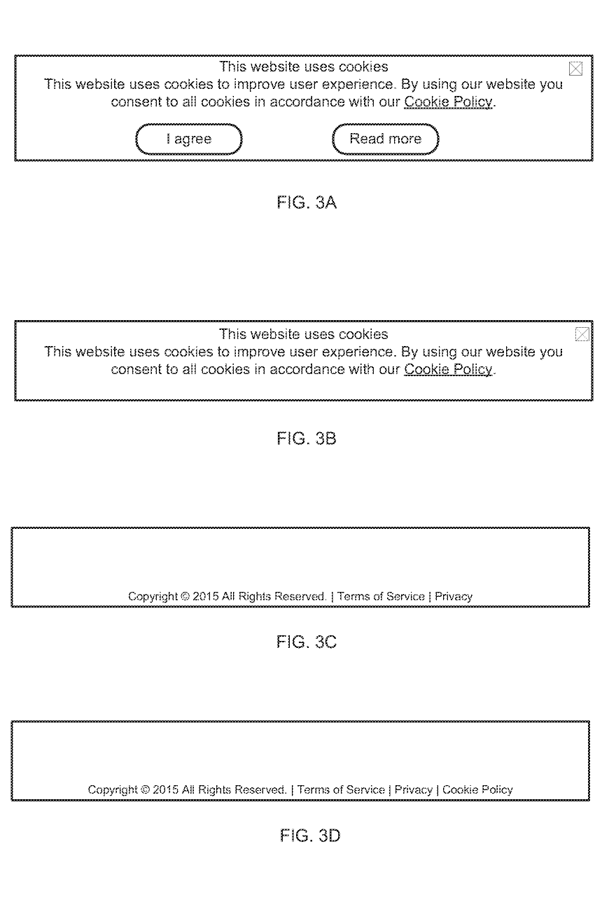

In one example, when an HTTP request is determined to be from a first time visitor and is determined to have originated from a particular country, such as the Netherlands, where explicit consent to the usage of online tracking tools is required, online behavioral tracking controller 230 may check online behavioral tracking policy database 240 for information regarding the online communication privacy regulations of the Netherlands and retrieve corresponding scripts, functions, rules or the like to implement the privacy regulations of the Netherlands. In accordance with the current online communication privacy regulations of the Netherlands, a cookie banner that requests explicit consent regarding cookie usage from a user is required to be shown before a cookie or other online behavioral tracking tools can be used by a web server. The regulations may also include detailed format requirements of the cookie banner, such as a position (e.g., top or bottom of the web page) at which the cookie banner is to be displayed, the font size of text within the cookie banner, standard statements of privacy policies, option buttons/links for acceptance or denial of online tracking. FIG. 3A shows a cookie banner including privacy policy statements, a consent link (the “I agree” button) and a privacy policy link (the “Read more” button). A script, such as a JavaScript function, may be used to implement the cookie banner as shown in FIG. 3A. The script may cause the user's browser to display a pop-up or floating window or banner including the statements and two buttons for the consent link and privacy policy link, respectively. The pop-up window may be displayed at a designated position, such as at the top/bottom of a web page.

When an HTTP response from a web server is intercepted by proxy module 210 and no cookie or other online behavioral tracking function is included in the HTTP response, online behavioral tracking controller 230 may embedded the script that implements the cookie banner as shown in FIG. 3A to the HTTP response. If online behavioral tracking tools, such as cookies, web beacons or cookie creating scripts, have been included in the HTTP response of the web server, those online behavioral tracking tools determined not to be in compliance with the regulations of the client's country or all included online behavioral tracking tools are removed from the HTTP response and a script that is in compliance with the regulations is embedded. The revised HTTP response is then sent to the client by proxy module 210. When the client receives the HTTP response, the script is run by the browser and a cookie banner that is in compliance with the regulations of the country of the client is shown to the user. The user may click the button or link to explicitly consent or deny the usage of online behavioral tracking tools and then an explicit consent or denial is then sent to reverse proxy 200. After reverse proxy 200 receives the explicit consent or denial of the client, information regarding the option selected by the client may be stored within online behavioral tracking policy database 240. If explicit consent is received from the client, the permitted cookies or other online behavioral tracking tools may be included in future communications with the client by online behavioral tracking controller 230 or the web server.

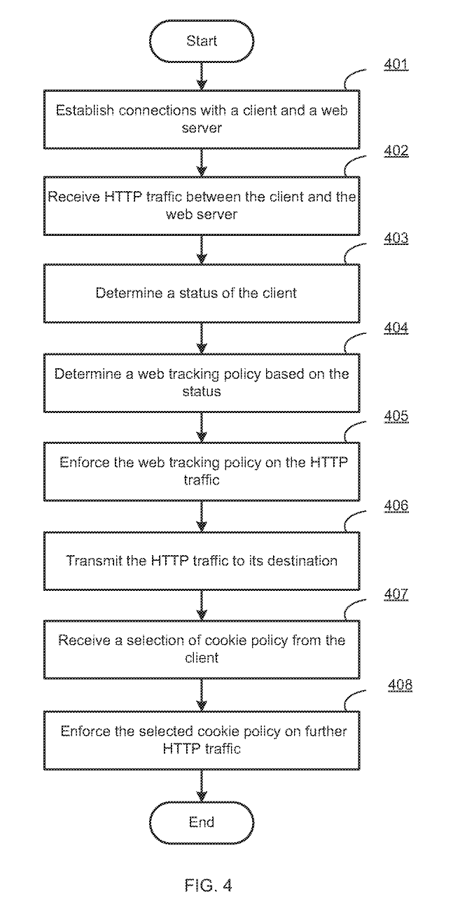

In another example, when an HTTP request is from a first time visitor and is originated from a country, such as the United Kingdom (UK), where implicit consent to the usage of online tracking tools is allowed, online behavioral tracking controller 230 may check online behavioral tracking policy database 240 for information regarding the online communication privacy regulations of the UK and corresponding scripts, functions, rules or the like to implement the regulations. Based on the online communication privacy regulations of the UK, a cookie banner is required to be shown by the web server. However, an implicit consent of cookie usage is allowable and the explicit consent is not required in the UK. FIG. 4B shows a cookie banner that includes privacy policy statements and a privacy policy link. No explicit consent button/link is shown in this cookie banner. When an HTTP response of a web server is intercepted by proxy module 210, the script that implements the cookie banner of FIG. 4B may be embedded within the HTTP response. Online behavioral tracking tools, including first-party HTTP cookies, third-party HTTP cookie scripts, first party/third party web beacons, may also be embedded within the HTTP response. The revised HTTP response is then sent to the client by proxy module 210. When the client receives the HTTP response, the script is run by the browser and a cookie banner that is in compliance with the regulations of the UK is shown to the user. In this example, the online behavioral tracking tools are transmitted to the client's browser directly because implicit consent is allowed by the regulations. Usually, an opt-out option may be provided by the web server through other ways, such as fax, telephone and/or a link provided by a privacy policy page or email in order to allow the user to explicitly opt-out of the online behavioral tracking tools by sending a message to the administrator of the web server. The web server may stop using online behavioral tracking tools in future communications with the client after receiving the opt-out message.

In a further example, when an HTTP request is from a first time visitor and is originated from a country, such as the United States (US), where a cookie banner is not required, online behavioral tracking controller 230 may check online behavioral tracking policy database 240 for information regarding the online communication privacy regulations of the US and corresponding scripts, functions, rules or the like to implement the regulations. Based on the online communication privacy regulations of the US, a cookie banner is not required to be shown to users before online tracking tools are used. However, the regulations of the US privacy laws require that a link to a cookie policy or a privacy policy that includes a cookie usage statement should be shown on a web page. FIG. 3C shows a web page that contains a link to a privacy policy of a website. The privacy policy may contain a cookie policy statement of the website. FIG. 3D shows a web page that contains a link to a cookie policy of a website. If no privacy policy link or cookie policy link is included in the HTTP response of the web server, online behavioral tracking controller 230 may embed a privacy policy link and/or a cookie policy link that are in compliance with the regulations of the country of the client from online behavioral tracking policy database 240 and embed the links within the HTTP response of the web server. The revised HTTP response is then sent to the client by proxy module 210. When the HTTP response is received by the client, a web page with a privacy policy link or cookie policy link like that of FIG. 3c or 3d is shown to the user.

In a further example, when an HTTP request is from a return visitor and the visitor has given an explicit/implicit consent to the usage of online behavioral tracking tools, online behavioral tracking controller 230 may allow usage of online behavioral tracking tools in the HTTP response if the HTTP response from the web server already included online behavioral tracking tools. If no online behavioral tracking tools are included in the HTTP response, online behavioral tracking controller 230 may embed one or more online behavioral tracking tools to the HTTP response based on the status of the client. The online behavioral tracking tools may include one or more of the following:
1. First-party cookies. A first-party HTTP cookie is an HTTP cookie of a web server that a web browser is accessing. A domain attribute of the first party cookie matches the web server's domain that is usually shown in the web browser's address bar. A first-party cookie may be embedded within a header field of an HTTP response of a web server. One or more scripts, such as JavaScript functions, that can create, read, change or delete cookies at the local machine of the client may be also embedded within the HTTP response. When the first-party HTTP cookie or the scripts are received and run by the browser, one or more first-party cookies may be created and stored on the local machine of the client.
2. First-party web beacons. A web beacon is typically a transparent graphic image (usually 1 pixel×1 pixel) and is placed on a web server or a web page hosted by the web server. Links to the web beacon may be embedded within the HTTP response. When the browser receives the HTTP response including the link to the web beacon, the browser displays the web page. As the first-party web beacon is deemed to be a component of the web page by the browser, the browser may fetch the first-party web beacon from the web server. The web server may record and store information regarding the histories of web beacon accesses in order to track the web surfing histories of clients.
3. Third-party HTTP cookie. A third-party HTTP cookie is an HTTP cookie of a third-party web server, such as an analytics server. The third-party HTTP cookie is transmitted to a browser or created at the browser when the browser is assessing a first-party web server and the owner of the third-party HTTP cookie is not shown in the web browser's address bar. Third-party scripts may be embedded within an HTTP response of the first-party web server. When the browser receives the HTTP response from the first-party web server, the third-party scripts may be run by the browser. Then, an HTTP connection to the third-party web server is established by the browser and one or more third-party HTTP cookies may be transmitted to the browser from the third-party web server. The third-party HTTP cookies may be stored locally at the client machine of the browser when the session with the third-party web server is over. When the browser accesses the third-party web server subsequently, the third-party HTTP cookies may be transmitted back to the third-party. The third-party may track the web surfing histories of clients through the third-party HTTP cookies.
4. One or more third-party web beacons. Links to the web beacons of a third-party web server may be embedded within the HTTP response. When the browser receives the HTTP response, the browser displays a web page of the web server. As the third-party web beacons are deemed as components of the web page by the browser, the browser may fetch the third-party web beacons from the third-party web server. The third-party may record and store the accesses of web beacons from clients in order to track the web surfing histories of the clients.

In the present embodiment, a reverse proxy is used as a centralized mechanism to manage and enforce the online behavioral tracking policy for multiple web servers. However, other network appliances may be used for implementing the centralized online behavioral tracking policy control. For example, embodiments of the present invention may be implemented within a firewall (e.g., one of the FortiGate family of firewalls/UTM appliances manufactured by the assignee of the present invention), an application delivery controller (ADC) (e.g., one of the FortiADC family of ADC appliances manufactured by the assignee of the present invention), an web server with load balancing functionality (e.g., one of the FortiWeb family of web servers manufactured by the assignee of the present invention) or other network security device that is deployed at a border of a private network to protect network appliances that connect to the private network.

In the present embodiment, HTTP cookies and web beacons are used as examples of online behavioral tracking tools. Those skilled in the art will appreciate that the techniques of the present invention may also be used in connection with controlling the usage policies of other online behavioral tracking tools, including, but not limited to, flash cookies, web storages, browser local storages and other web tools that may be used for tracking users' web surfing activities.

FIG. 4 is a flow diagram illustrating a method for enforcing online behavioral tracking policies by a reverse proxy in accordance with an embodiment of the present invention. The method may be implemented at a reverse proxy as shown in FIGS. 1 and 2 or other network security devices (e.g., a firewall, gateway or UTM appliance) logically interposed between a requesting client (e.g., a web browser) and a server (e.g., a web server).

At block 401, the reverse proxy establishes a TCP connection with the client and another TCP connection with a web server. The reverse proxy may select the web server from multiple web servers that are connected to the reverse proxy based on a load balancing policy.

At block 402, the reverse proxy receives HTTP traffic between the client and the web server. In this example, reverse proxy may receive an HTTP request from the client and then forward it to the web server. The web server processes the HTTP request and sends an HTTP response to the reverse proxy.

At block 403, the reverse proxy may determine a status of the client. The status is used to determine an online behavioral tracking policy that is to be applied to communications with the client. The status of the client may comprise one or more of a location of the client, whether the client is a first time visitor or a return visitor, one or more online behavioral tracking policy options made by the client and a time associated with the client's last access (or a time that has elapsed since the client's last access).

The location of the client can be determined based on an IP address of the client, which is the source IP address of the HTTP request and the destination IP address of the HTTP response. Based on the IP address, a physical location, such as a country in which the client resides, may be determined by the reverse proxy based on an IP address-to-country database or an IP address-to-geolocation service provider. The physical location may also be provided by the client if the client is equipped with a GPS module or other location identification means.

In one example, the status of first time visitor/return visitor can be determined by the presence or absence of an HTTP cookie within the HTTP request sent by the client. Based on the HTTP protocol, when a client receives an HTTP cookie of a web server, the HTTP cookie is stored at the local machine of the client after the session with the web server is closed. When the client subsequently accesses the web server, the HTTP cookie of the web server is included in the HTTP request if the HTTP cookie is still valid. The reverse proxy may determine that the client is a return visitor when a valid HTTP cookie of the web server is received by the reverse proxy. On the other hand, when no HTTP cookie of the web server is incorporated in the HTTP request message, the reverse proxy may determine that the client is a first time visitor.

In another example, the status of first time visitor/return visitor can be determined by web beacons associated with the web server. A web beacon that can be used to identify a client may be placed on the web server or reverse proxy. A browsing log may be used for recording the access history of the web beacon. If the web beacon is accessed again by the client based on the browsing log, the reverse proxy may determine that the client is a return visitor. Otherwise, the client may be treated as a first time visitor.

In a further example, the status of first time visitor/return visitor can be determined by a browsing log of the web server. A browsing log may be used for recording the access history of the client. The reverse proxy may determine that the client is a return visitor if there is an access history for the client in the browsing log. Otherwise, the client may be treated as a first time visitor.

Further, if the client is a return visitor, an amount of time that has elapsed since the last visit may be calculated by the reverse proxy.

At block 404, the reverse proxy may determine an online behavioral tracking policy to be applied to the HTTP traffic based on the status of the client. If the client is a first time visitor, the reverse proxy may identify appropriate online communication privacy regulations based on the client's country. If a cookie banner that informs the client regarding the potential usage of cookies is required by the regulations of the client's country, the reverse proxy may further determine any format requirements for the cookie banner. The format requirements of the cookie banner may include the position, font size and explicit consent/denial options of the cookie banner. For a return visitor, the reverse proxy may further determine if the client has given consent to the usage of any online behavioral tracking tools. For example, the client may give consent to the usage of HTTP cookies of the web server by clicking a button or a link presented within the cookie banner that is displayed on a web page of the web server. The consent of the client may be recorded by the reverse proxy or the web server. The reverse proxy may further collect the client's consent for usage of particular online behavioral tracking tools in order to control the usage of online behavioral tracking tools accordingly. The reverse proxy may provide options to clients and allow the clients to determine the types of online behavioral tracking tools that are allowed, including, but not limited to, HTTP cookies, web beacons, flash cookies and local storages of browsers. The reverse proxy may also provide options to clients to determine if first-party or third-party tracking tools are allowed or not. A whitelist/blacklist of third-party online behavioral tracking tools of clients may also be stored at the reverse proxy or the web server.

At block 405, the reverse proxy enforces the online behavioral tracking policy by applying it to the HTTP response that is to be sent to the client. After an HTTP response from the web server is received by the reverse proxy, the reverse proxy may check if online behavioral tracking tools were already included in the HTTP response by the web server. If no online behavioral tracking tools have been included by the web server, an HTTP cookie of the web server may be incorporated within a header field of the HTTP response message if the HTTP cookie is allowed based on the status of the client. Alternatively or additionally, a script, such as JavaScript, that creates an HTTP cookie of the web server may also be embedded within the HTTP response message. Links to privacy policy and/or cookie policy, links to first-party and/or third party web beacons, scripts that create a cookie banner and scripts to access third-party HTTP cookies may be also be embedded within the HTTP response based on the status of the client. If online behavioral tracking tools were already included in the HTTP response by the web server, they may be removed from the HTTP response as the tools may be not in compliance with the online communication privacy regulations of the client's country. After the online behavioral tracking tools are removed, online behavioral tracking tools, if any, that are deemed to be in compliance with the status of the client may be embedded or incorporated within the HTTP response message.

At block 406, the reverse proxy transmits the revised HTTP response message to the client. After the client receives the HTTP response, a web page may be presented to the user. For the first time visitor for whom an explicit consent to the usage of online behavioral tracking tools is required by the online communication privacy regulations at issue, a pop-up or floating window or banner that allows the user to agree to or disagree to the usage of online behavioral tracking tools may be presented to the user. The user may click an option button/link shown on the cookie banner to give explicit consent or denial to the usage of online behavioral tracking tools.

At block 407, the reverse proxy may receive an option, such as an explicit consent or denial to the usage of online behavioral tracking tools, from the client.

At block 408, the reverse proxy may store the option and enforce the user's option in connection with future HTTP traffic directed to the client. For example, if the usage of first-party HTTP cookies are allowed by the client, a first-party HTTP cookie may be included in subsequent HTTP responses to the client. If the usage of first-party HTTP cookies is denied by the client, no HTTP cookie or scripts that create such cookies at the client machine will be embedded within the HTTP response and if such cookies or scripts have been included by the responding web server, they will be removed by the reverse proxy.

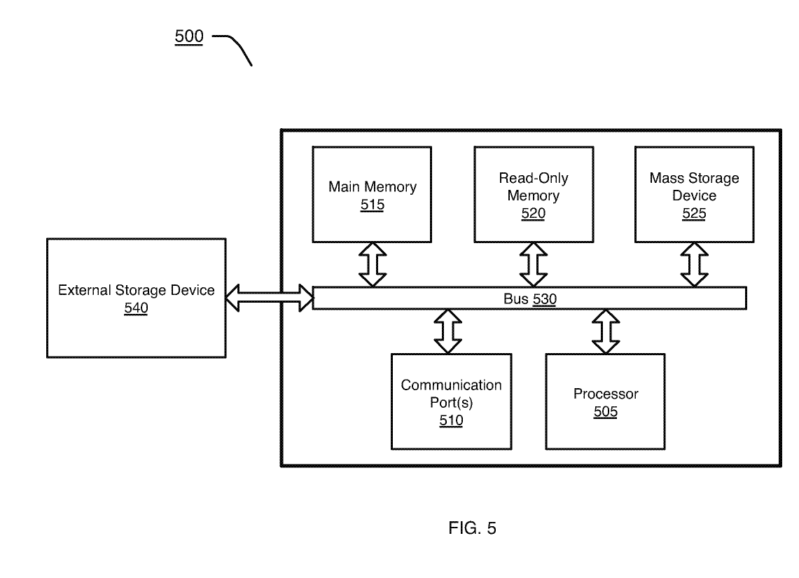

FIG. 5 is an example of a computer system 500 with which embodiments of the present disclosure may be utilized. Computer system 500 may represent or form a part of a network appliance, network security device or a proxy server (e.g., reverse proxy 140 or 200) that is logically interposed between a client and one or more web servers.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 500 includes a bus 530, a processor 505, communication port 510, a main memory 515, a removable storage media 540, a read only memory 520 and a mass storage 525. A person skilled in the art will appreciate that computer system 500 may include more than one processor and communication ports.

Examples of processor 505 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 505 may include various modules associated with embodiments of the present invention.

Communication port 510 can be any of an RS-232 port for use with a modem based dialup connection, a 10/100 Ethernet port, a Gigabit or 10 Gigabit port using copper or fiber, a serial port, a parallel port, or other existing or future ports. Communication port 510 may be chosen depending on a network, such a Local Area Network (LAN), Wide Area Network (WAN), or any network to which computer system 500 connects.

Memory 515 can be Random Access Memory (RAM), or any other dynamic storage device commonly known in the art. Read only memory 520 can be any static storage device(s) such as, but not limited to, a Programmable Read Only Memory (PROM) chips for storing static information such as start-up or BIOS instructions for processor 505.

Mass storage 525 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 530 communicatively couples processor(s) 505 with the other memory, storage and communication blocks. Bus 530 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 505 to system memory.

Optionally, operator and administrative interfaces, such as a display, keyboard, and a cursor control device, may also be coupled to bus 530 to support direct operator interaction with computer system 500. Other operator and administrative interfaces can be provided through network connections connected through communication port 510.

Removable storage media 540 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
capturing, by a network security device, a hypertext transfer protocol (HTTP) response transmitted from a web server to a client;
determining, by the network security device, a status of the client;
identifying, by the network security device, an online behavioral tracking policy associated with the client based on the determined status;
enforcing, by the network security device, the identified online behavioral tracking policy by modifying the HTTP response; and
transmitting, by the network security device, the modified HTTP response to the client.

2. The method of claim 1, wherein the status of the client comprises one or more of:
a location of the client;
a visitation history;
an online behavioral tracking policy acceptance history; and
information regarding an amount of time that has elapsed since a last access by the client.

3. The method of claim 2, wherein the location of the client is determined based on an Internet Protocol (IP) address of the client.

4. The method of claim 2, further comprising:
capturing, by the network security device, an HTTP request transmitted by the client to the web server;
detecting, by the network security device, whether an HTTP cookie is embedded within the HTTP request;
when a result of the detecting is negative, then the client is treated as a first time visitor; and
when the result of the detecting is affirmative, then the client is treated as a return visitor.

5. The method of claim 2, further comprising:
capturing, by the network security device, an HTTP request transmitted by the client to the web server;
determining, by the network security device, the HTTP request comprises a web beacon request for a web beacon;
checking, by the network security device, a browsing log associated with the client for the web beacon;
when the web beacon is found within the browsing log, the client is determined to be a return visitor; and
when the web beacon is not found within the browsing log, the client is determined to be a first time visitor.

6. The method of claim 1, wherein the online behavioral tracking policy includes information regarding online communication privacy regulations of a country in which the client is physically located.

7. The method of claim 1, wherein the online behavioral tracking policy includes indications regarding one or more of:
whether a web beacon is allowed in connection with communications with the client;
whether an HTTP cookie is allowed in connection with communications with the client;
whether a first-party is allowed in connection with communications with the client;
whether a third-party HTTP cookie is allowed in connection with communications with the client;
whether a whitelist and/or blacklist of third-party HTTP cookies;
whether a privacy policy link is to be displayed by the client;
whether a cookie banner is to be displayed by the client; and
whether one or more user options are to be included within the cookie banner.

8. The method of claim 1, wherein said enforcing, by the network security device, the identified online behavioral tracking policy comprises one or more of:
removing one or more online behavioral tracking tools that are not in compliance with the identified online behavioral tracking policy from the HTTP response; and
embedding one or more online behavioral tracking tools that are in compliance with the identified online behavioral tracking policy within the HTTP response.

9. The method of claim 8, wherein the online behavioral tracking tool comprises one or more of:
an HTTP cookie;
a web beacon;
a local storage of a browser;
a flash cookie;
a script that creates an online behavioral tracking tool when run by the client.

10. The method of claim 8, wherein said enforcing, by the network security device, the identified online behavioral tracking policy further comprises one or more of:
embedding within the modified HTTP response a script that causes the client to display a link to a privacy policy of the web server;
embedding within the modified HTTP response a script that causes the client to display a cookie banner; and
embedding within the modified HTTP response a script that prompts for an option regarding an online behavioral tracking policy within a cookie banner.

11. The method of claim 1, further comprising:
receiving, by the network security device, an option relating to the online behavioral tracking policy from the client; and
enforcing, by the network security device, the option on subsequent HTTP traffic directed to the client.

12. The method of claim 1, wherein the network security device comprises or implements a reverse proxy.

13. The method of claim 12, further comprising:
establishing, by the reverse proxy, a first connection with the client;
establishing, by the reverse proxy, a second connection with the web server;
removing, by the reverse proxy, an online behavioral tracking tool from the HTTP response received on the second connection with the web server; and
enforcing, by the reverse proxy, the online behavioral tracking policy on the HTTP response to be sent on the first connection with the client.

14. A network security device comprising:
non-transitory storage device having tangibly embodied therein instructions representing a security application; and
one or more processors coupled to the non-transitory storage device and operable to execute the security application to perform a method comprising:
capturing a hypertext transfer protocol (HTTP) response transmitted from a web server to a client;
determining a status of the client;
identifying an online behavioral tracking policy associated with the client based on the determined status;
enforcing the identified online behavioral tracking policy by modifying the HTTP response; and
transmitting the modified HTTP response to the client.

15. The network security device of claim 14, wherein the status of the client comprises one or more of:
a location of the client;
a visitation history;
an online behavioral tracking policy acceptance history; and
information regarding an amount of time that has elapsed since a last access by the client.

16. The network security device of claim 15, wherein the location of the client is determined based on an Internet Protocol (IP) address of the client.

17. The network security device of claim 15, wherein the method further comprises:
capturing an HTTP request transmitted by the client to the web server;
detecting whether an HTTP cookie is embedded within the HTTP request;
when a result of the detecting is negative, then the client is treated as a first time visitor; and
when the result of the detecting is affirmative, then the client is treated as a return visitor.

18. The network security device of claim 15, wherein the method further comprises:
capturing an HTTP request transmitted by the client to the web server;
determining the HTTP request comprises a web beacon request for a web beacon;
checking, by the network security device, a browsing log associated with the client for the web beacon;
when the web beacon is found within the browsing log, the client is determined to be a return visitor; and
when the web beacon is not found within the browsing log, the client is determined to be a first time visitor.

19. The network security device of claim 16, wherein the online behavioral tracking policy includes information regarding online communication privacy regulations of a country in which the client is physically located.

20. The network security device of claim 14, wherein the online behavioral tracking policy includes indications regarding one or more of:
whether a web beacon is allowed in connection with communications with the client;
whether an HTTP cookie is allowed in connection with communications with the client;
whether a first-party is allowed in connection with communications with the client;
whether a third-party HTTP cookie is allowed in connection with communications with the client;
whether a whitelist and/or blacklist of third-party HTTP cookies;
whether a privacy policy link is to be displayed by the client;
whether a cookie banner is to be displayed by the client; and
whether one or more user options are to be included within the cookie banner.

21. The network security device of claim 14, wherein said enforcing the identified online behavioral tracking policy comprises one or more of:
removing one or more online behavioral tracking tools that are not in compliance with the identified online behavioral tracking policy from the HTTP response; and
embedding one or more online behavioral tracking tools that are in compliance with the identified online behavioral tracking policy within the HTTP response.

22. The network security device of claim 21, wherein the online behavioral tracking tool comprises one or more of:
an HTTP cookie;
a web beacon;
a local storage of a browser;
a flash cookie;
a script that creates an online behavioral tracking tool when run by the client.

23. The network security device of claim 21, wherein said enforcing the identified online behavioral tracking policy further comprises one or more of:
embedding within the modified HTTP response a script that causes the client to display a link to a privacy policy of the web server;
embedding within the modified HTTP response a script that causes the client to display a cookie banner; and
embedding within the modified HTTP response a script that prompts for an option regarding an online behavioral tracking policy within a cookie banner.

24. The network security device of claim 14, wherein the method further comprises:
receiving an option relating to the online behavioral tracking policy from the client; and
enforcing the option on subsequent HTTP traffic directed to the client.

25. The network security device of claim 14, wherein the network security device comprises or implements a reverse proxy.

26. The network security device of claim 25, wherein the method further comprises:
establishing, by the reverse proxy, a first connection with the client;
establishing, by the reverse proxy, a second connection with the web server;
removing, by the reverse proxy, an online behavioral tracking tool from the HTTP response received on the second connection with the web server; and
enforcing, by the reverse proxy, the online behavioral tracking policy on the HTTP response to be sent on the first connection with the client.
